(19) United States
(12) Patent Application Publication
(10) Pub. No.: US 2024/0342870 A1
(43) Pub. Date: Oct. 17, 2024

(54) ELECTRIC RATCHET WRENCH

(71) Applicant: BASSO INDUSTRY CORP., Taichung (TW)

(72) Inventor: Yu-Da CHEN, Taichung (TW)

(73) Assignee: BASSO INDUSTRY CORP., Taichung (TW)

(21) Appl. No.: 18/632,820

(22) Filed: Apr. 11, 2024

(30) Foreign Application Priority Data
Apr. 12, 2023 (TW) 112203335

(51) Int. Cl. B25B 21/00; B25F 5/00; B25F 5/02

(52) U.S. Cl. CPC B25B 21/004; B25F 5/001; B25F 5/02

(57) ABSTRACT

An electric ratchet wrench includes a tool head unit, a wrench body unit, an output unit, an electric unit, and a control unit. The wrench body unit defines a front space, a middle space and a rear space, and includes a support ring including front and rear ring sections that surround respectively the front and middle spaces. The electric unit includes an electric motor connected to the rear ring section and converting electrical energy to kinetic energy, and a transmission subunit connected to the front ring section, and transmitting the kinetic energy to a head driver of the output unit. The control unit includes a control module signally connected to the electric motor, and a battery module electrically connected to the control module, and providing the electrical energy.

### CROSS-REFERENCE TO RELATED APPLICATION

This application claims priority to Taiwanese Utility Model Patent Application No. 11/220,3335, filed on Apr. 12, 2023, the entire disclosure of which is incorporated by reference herein.

### FIELD

The disclosure relates to an electric ratchet wrench, and more particularly to an electric ratchet wrench with a built-in battery.

### BACKGROUND

Referring to FIGS. 1 and 2, a conventional electric ratchet wrench 1 disclosed in U.S. Patent Application Publication No. 20220266439 includes a tool head portion 11, a main body 12 connected to the tool head portion 11, an output member 13 mounted to the tool head portion 11 and configured to output rotational energy, a motor 14 mounted to the main body 12 and operable for converting electrical energy to kinetic energy, a battery cell 15 mounted to the main body 12 for providing the electrical power to the motor 14, a front cover 16 mounted between the tool head portion 11 and the main body 12, a deceleration gear set 17 sleeved on the front cover 16 and transmitting the kinetic energy, and a crown portion 18 disposed movably between the tool head portion 11 and the main body 12 and for turning on the motor 14. The main body 12 includes a support tube 121 surrounding the front cover 16 and the motor 14, and a handle 122 surrounding the support tube 121 and for gripping.

However, since the front cover 16, the deceleration gear set 17, and the support tube 121 are sequentially sleeved on one another one by one, an overall volume of the conventional electric ratchet wrench 1 is relatively large and is difficult to be reduced. In addition, it is troublesome to turn on the motor 14 by moving the crown portion 18 in a lengthwise direction of the main body 12.

### SUMMARY

Therefore, an object of the disclosure is to provide an electric ratchet wrench that can alleviate at least one of the drawbacks of the prior art.

According to the disclosure, the electric ratchet wrench includes a tool head unit, a wrench body unit, an output unit, an electric unit, and a control unit. The wrench body unit is detachably connected to the tool head unit, extends along a first axis, includes a support ring, a sleeve member, and a connecting ring, and defines a front space that is proximate to the tool head unit, a rear space that is opposite to the front space along the first axis, and a middle space that is disposed between and in spatial communication with the front space and the rear space. The support ring includes a front ring section that surrounds the front space and that is connected to the tool head unit, and a rear ring section that is opposite to the front ring section along the first axis and that surrounds the middle space. The sleeve member surrounds a portion of the support ring and the rear space. The connecting ring threadedly engages the front ring section of the support ring and the tool head unit such that the wrench body unit is connected to the tool head unit and is detachable from the tool unit along the axis. The output unit includes a head driver that is mounted on the tool head unit, extends along a second axis transverse to the first axis, and is configured to rotate in a selected direction and output rotational energy. The electric unit includes an electric motor that is mounted in the middle space, that is connected to the rear ring section, and that converts electrical energy to kinetic energy, and a transmission subunit that is mounted in the front space, that is connected to the front ring section, and that is configured for transmitting the kinetic energy to the head driver. The control unit is mounted to the wrench body unit and includes a control module that is signally connected to the electric motor, and a battery module that is disposed in the rear space, that is electrically connected to the control module, and that is configured to provide the electrical energy.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a partly fragmentary exploded perspective view of a conventional electric ratchet wrench disclosed in U.S. Patent Application Publication No. 20220266439.

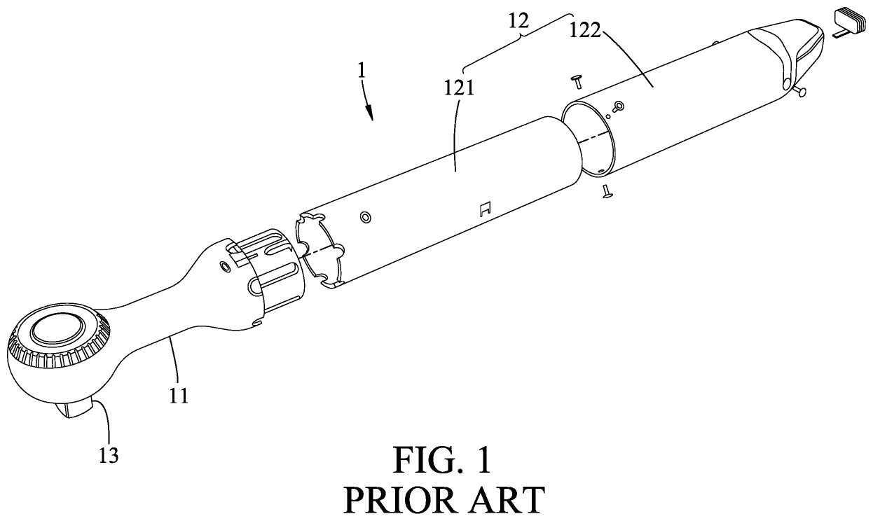

FIG. 2 is a schematic front view of the conventional electric ratchet wrench.

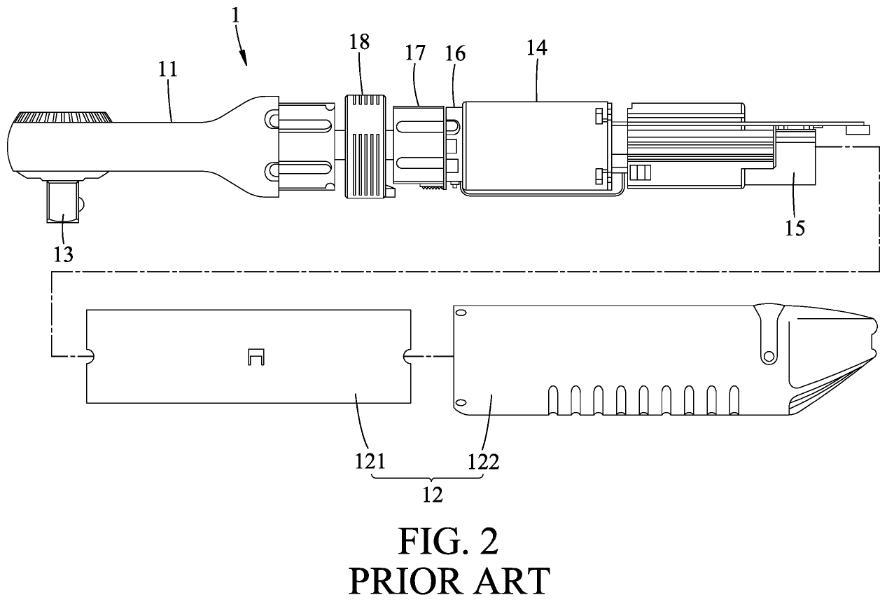

FIG. 3 is a perspective view of an embodiment of an electric ratchet wrench according to the present disclosure.

FIG. 4 is a sectional view of the embodiment, illustrating a trigger of the electric ratchet wrench at a normal position.

FIG. 5 is a partly exploded perspective view of the embodiment.

FIG. 6 is an exploded perspective view of a transmission subunit and a support ring of the embodiment.

FIG. 7 is a sectional view taken along line VII-VII in FIG. 4.

FIG. 8 is a view similar to FIG. 4, but illustrating the trigger at a pressing position.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features May be oriented differently (e.g., rotated 90 degrees or at other orientations) and the spatially relative terms used herein may be interpreted accordingly.

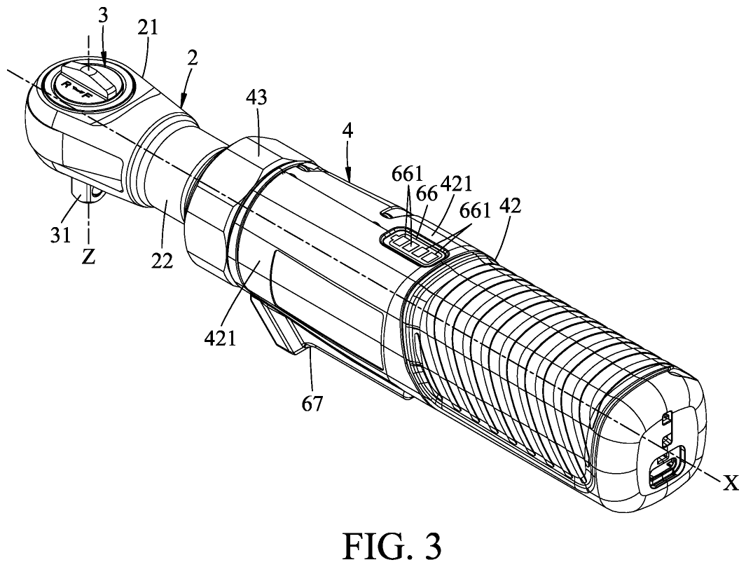

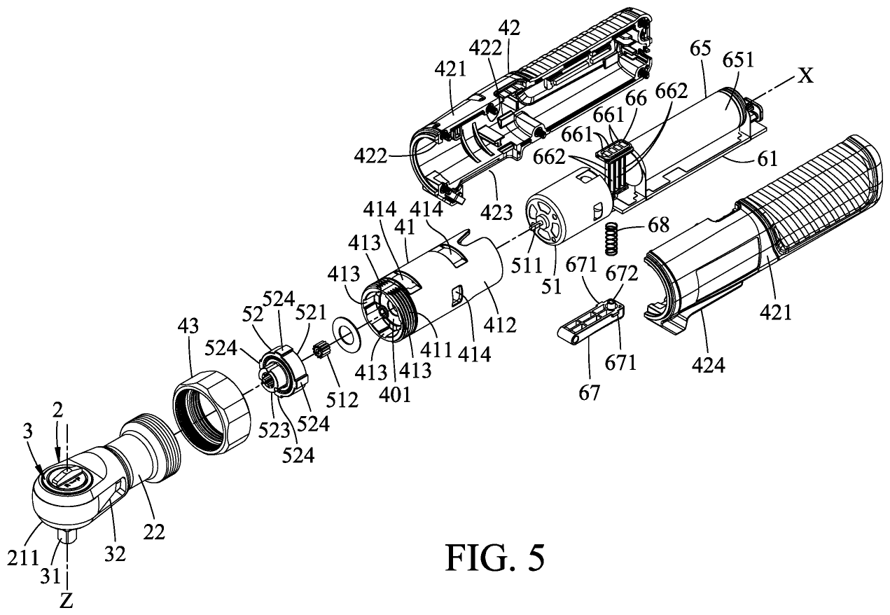

Referring to FIGS. 3, 4, and 5, an electric ratchet wrench of an embodiment according to the present disclosure includes a tool head unit 2, an output unit 3, a wrench body unit 4, an electric unit 5, and a control unit 6.

In this embodiment, the tool head unit 2 includes an H-shaped section 21, and a neck portion 22 connected to the H-shaped section 21 and extending along a first axis.

The output unit 3 includes a head driver 31 and a yoke 32.

The head driver 31 is mounted to the H-shaped section 21 of the tool head unit 2, extends along a second axis transverse to the first axis, and is configured to rotate in a selected direction, and output a rotational energy. It should be noted that in this embodiment, the second axis is substantially perpendicular to the first axis.

The yoke 32 includes an annular toothed portion 321 surrounding the head driver 31, and an activated portion 322 extending into the neck portion 22

Since the output unit 3 is well known in the pertinent art and is not the distinctive feature of the present disclosure, further details of the same are omitted in the following description for the sake of brevity.

The wrench body unit 4 extends along the first axis and is detachably connected to the neck portion 22 of the tool head unit 2. The wrench body unit 4 includes a support ring 41 surrounding the first axis and defining a front space 401 and a middle space 402, a sleeve member 42 surrounding a portion of the support ring 41 and defining a rear space 403, and a connecting ring 43 connected to the support ring 41 and opposite to the sleeve member 42 along the first axis. The front space 401, the middle space 402, and the rear space 403 are sequentially disposed on the first axis. The middle space 402 is in spatial communication with the front space 401 and the rear space 403.

The support ring 41 includes a front ring section 411 surrounding the front space 401, and a rear ring section 412 opposite to the front ring section 411 along the first axis and surrounding the middle space 402. The front ring section 411 has a plurality of grooves 413 formed in an inner surface thereof and extending from a rim thereof toward the rear ring section 412. The rear ring section 412 has a plurality of slots 414 formed through an outer surface and an inner surface of the rear ring section 412.

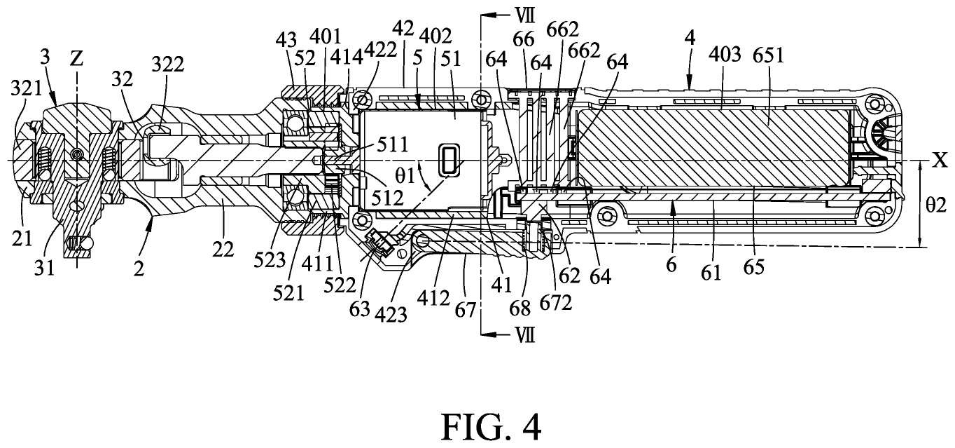

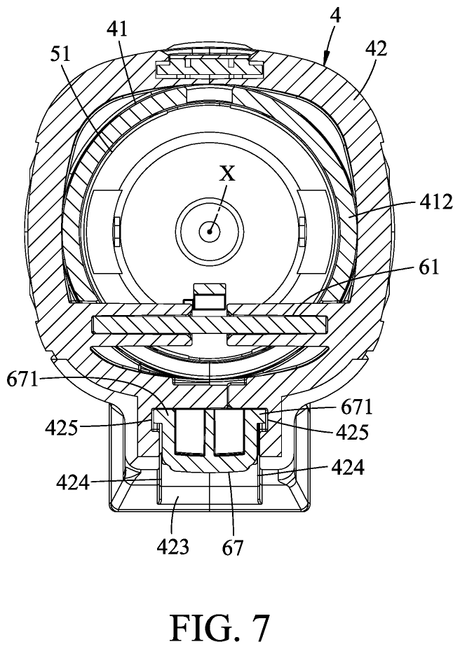

Referring to FIGS. 4, 5, and 7, in this embodiment, the sleeve member 42 consists of two halves 421 engaging each other, and includes a plurality of protrusions 422 formed on an inner surface thereof and engaging respectively the slots 414 of the rear ring section 412. It should be noted that the number of the protrusions 422 is the same as that of the slots 414 and is four in this embodiment. By virtue of the connection among the protrusions 422 and the slots 414, connection strength between the sleeve member 42 and the support ring 41 is increased. The sleeve member 42 has two receiving portion defining walls 424 extending from an outer surface thereof in directions substantially parallel to the second axis and toward the support ring 41 to define a receiving portion 423, and two guiding grooves 425 formed respectively in the receiving portion defining walls 424.

The connecting ring 43 threadedly engages the front ring section 411 of the support ring 41 and the neck portion 22 of the tool head unit 2, such that the wrench body unit 4 is connected to the tool head unit 2 and is detachable from the tool head unit 2 along the axis.

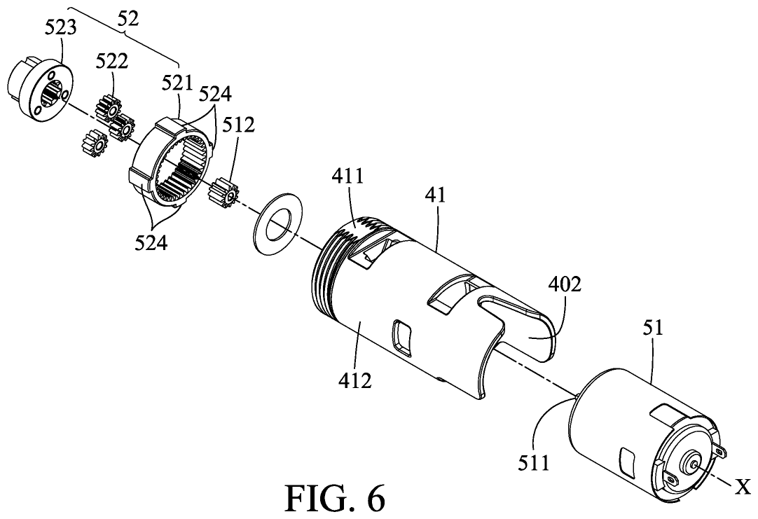

Referring to FIGS. 4 to 6, the electric unit 5 includes an electric motor 51 and a transmission subunit 52.

The electric motor 51 is mounted in the middle space 402 and is connected to the rear ring section 412 of the support ring 41. The electric motor 51 is operable for converting electrical energy to kinetic energy, and includes a spindle 511 extending into the front space 401 and rotatable about the first axis, and a transmission gear 512 sleeved on and co-rotatably connected to the spindle 511.

The transmission subunit 52 is mounted in the front space 401 and is connected to the front ring section 411. The transmission subunit 52 is configured to transmit the kinetic energy from the electric motor 51 to the head driver 31. In this embodiment, the transmission subunit 52 includes an internal gear ring 521 engaging the front ring section 411, a plurality of planetary gears 522 meshing with the internal gear ring 521 and engaging the transmission gear 512 so as to be connected co-rotatably to the spindle 511, and a gear plate 523 connected to the planetary gears 522 and the yoke 32. The internal gear ring 521 includes a plurality of ribs 524 formed on an outer surface thereof and engaging respectively the grooves 413. In this embodiment, the grooves 413 are equiangularly spaced apart from one another and the ribs 524 are complementary in shape with and aligned with the grooves 413, respectively. Furthermore, the number of the ribs 524 is the same as the number of the grooves 413 and is four in this embodiment. The gear plate 523 meshes with and is driven by the planetary gears 522 to rotate the yoke 32 and transmit the kinetic energy to the head driver 31.

The control unit 6 is mounted to the wrench body unit 4, and includes a control module 61, a sensor 62, a first light emitting element 63, four second light emitting elements 64, a battery module 65, an indicating member 66, a trigger 67, and a resilient element 68.

The control module 61 is disposed in a portion of the middle space 402 and the rear space 403, and is signally connected to the electric motor 51.

The sensor 62 is electrically connected to the control module 61, and is operable to output a sensing signal to the control module 61 as being pressed by the trigger 67. The trigger 67 is connected to the sleeve member 42, is disposed in the receiving portion 423 defined by the receiving portion defining walls 424, and is operable to turn on the electric motor 51.

The first light emitting element 63 is mounted to the sleeve member 42 and is electrically connected to the control module 61. In this embodiment, the first light emitting element 63 is disposed between the neck portion 22 of the tool head unit 2 and the trigger 67, and is configured to emit a light beam substantially toward the second axis. A first included angle (θ1) is defined between the light beam emitted by the first light emitting member 63 and the first axis, and ranges from 40 degrees to 50 degrees. In this embodiment, the first included angle (θ1) is 45 degrees.

The second light emitting elements 64 are electrically connected to the control module 61 and are arranged in a direction parallel to the first axis.

The battery module 65 is disposed in the rear space 403, is electrically connected to the control module 61, and is configured to provide the electrical energy. In this embodiment, the battery module 65 includes a battery 651 providing the electrical energy to the electric motor 51, the control module 61, the sensor 62, the first light emitting element 63, and the second light emitting elements 64. The battery 651 is a rechargeable lithium-battery storing electrical energy, but the present disclosure is not limited hereto.

Referring to FIGS. 4, 5, 7 and 8, the indicating member 66 is mounted to the sleeve member 42 of the wrench body unit 4 for indicating a residual power of the battery module 65. The indicating member 66 includes four windows 661 arranged in a direction parallel to the first axis, and four light guiding strips 662 each disposed between a respective one of the windows 661 and a respective one of the second light emitting elements 64 for guiding a light beam emitted from the respective one of the second light emitting elements 64 toward the respective one of the windows 661.

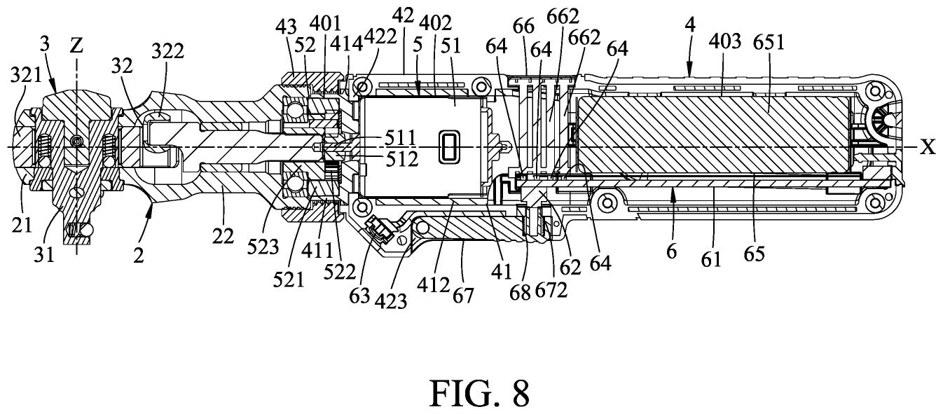

The trigger 67 is pivotably connected to the sleeve member 42, and is movably disposed in the receiving portion 423. Specifically, the trigger 67 includes two flange portions 671 formed at two opposite sides thereof and received respectively in the guiding grooves 425, and a triggering portion 672 extending toward and movable relative to the sensor 62 in a direction substantially parallel to the second axis. The trigger 67 is pivotable relative to the sleeve member 42 between a pressing position (see FIG. 8) and a normal position (see FIG. 4). When the trigger 67 is at the pressing position, the triggering portion 672 of the trigger 67 presses against the sensor 62. When the trigger 67 is at the normal position, the triggering portion 672 of the trigger 67 is spaced apart from the sensor 62 and the trigger 67 cooperates with the first axis to define a second included angle (θ2) that ranges from 2 degrees to 5 degrees therebetween. In this embodiment, the second angle (θ2) is 3 degrees.

The resilient element 68 is mounted between the sleeve member 42 and the trigger 67, and provides a force for biasing the trigger 67 away from the sensor 62 to the normal position.

It should be noted that the control module 61 is configured to turn on the electric motor 51 and the first light emitting element 63 upon receipt of the sensing signal from the sensor 62, to turn off the electric motor 51 when not receiving the sensing signal while the sensor 62 is not pressed by the triggering portion 672, and to turn off the first light emitting element 63 after a predetermined period has elapsed since the electric motor 51 is turned off. In this embodiment, the predetermined period is 10 seconds, but is not limited hereto.

The control module 61 is further configured to turn on the second

light emitting elements 64 based on the residual power of the battery module 65. The number of the second light emitting elements 64 that are turned on is in positive correlation to the residual power of the battery module 65. For example, a percentage of the residual power of the battery module 65 may be an arithmetic progression of 25, 50, 75, and 100. When the percentage of the residual power of the battery module 65 is 100%, the control module 61 turns on four of the second light emitting elements 64. In this way, the light beam emitted by each of the second light emitting elements 64 propagates along a respective one of the light guiding strips 662 toward the respective one of the windows 661, so that light is emitted outwardly of four of the windows 661. Similarly, when the percentage of the residual power of the battery module 65 is 75%, the control module 61 turns on three of the second light emitting elements 64. When the percentage of the residual power of the battery module 65 is 50%, the control module 61 turns on two of the second light emitting elements 64. When the percentage of the residual power of the battery module 65 is 25%, the control module 61 turns on one of the second light emitting elements 64. When the percentage of the residual power of the battery module 65 is 0%, the control module 61 does not turn on the second light emitting elements 64, so four of the second light emitting elements 64 do not emit light.

When a user grips the wrench body unit 4 and presses the trigger 67 to move the trigger 67 to the pressing position, the triggering portion 672 presses against the sensor 62 so the sensor 62 outputs the sensing signal to the control module 61. In this way, the control module 61 turns on the electric motor 51 and the first light emitting element 63 upon the receipt of the sensing signal.

At this time, the first light emitting element 63 emits the light beam substantially toward the second axis, so that a bolt or a nut (not shown) disposed under and to be driven by the head driver 31 falls within a lighting range of the first light emitting element 63 and is illuminated.

The kinetic energy from the electric motor 51 is transmitted by the

transmission subunit 52 to drive the activated portion 322 of the yoke 32 to pivot, and to drive the head driver 31 to rotate about the second axis via the annular toothed portion 321, thereby allowing the electric ratchet wrench to fasten or loosen a bolt or a nut (not shown).

When the user releases the trigger 67, the trigger 67 returns back to the normal position by virtue of the resilient element 68, the sensor 62 stops outputting the sensing signal to the control module 61 so the electric motor 51 is immediately turned off, and the first light emitting element 63 is turned off after the predetermined period, e.g., 10 seconds, has elapsed since the electric motor 51 is turned off.

In conclusion, the advantages of the embodiments are as follows:

First, by virtue of the support ring 41, the structural strength of the electric ratchet wrench is relatively high, a relatively smooth appearance without step difference may be provided, and an overall volume occupied by the electric ratchet wrench is relatively compact.

Second, the electric motor 51 may be activated by simply pressing the trigger 67 by a finger that grips the wrench body unit 4, which is quite convenient and easy to use.

Third, the first light emitting element 63 illuminates elements that are to be driven by the electric ratchet wrench, which is helpful when the electric ratchet wrench is used.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electric ratchet wrench comprising:
a tool head unit;
a wrench body unit that extends along a first axis, that is detachably connected to said tool head unit, that defines a front space proximate to said tool head unit, a rear space opposite to said front space along the first axis, and a middle space disposed between and in spatial communication with said front space and said rear space, and that includes
a support ring including:
a front ring section that surrounds said front space and that is connected to said tool head unit; and
a rear ring section that is opposite to said front ring section along the first axis and that surrounds said middle space,
a sleeve member surrounding a portion of said support ring and said rear space, and
a connecting ring threadedly engaging said front ring section of said support ring and said tool head unit such that said wrench body unit is connected to said tool head unit and is detachable from said tool head unit along the axis;
an output unit that includes a head driver mounted on said tool head unit, that extends along a second axis transverse to the first axis, and that is configured to rotate in a selected direction and output rotational energy;
an electric unit that includes
an electric motor mounted in said middle space, connected to said rear ring section, and operable for converting electrical energy to kinetic energy, and
a transmission subunit mounted in said front space, connected to said front ring section, and configured for transmitting the kinetic energy to said head driver; and
a control unit that is mounted to said wrench body unit and that includes
a control module signally connected to said electric motor, and
a battery module disposed in said rear space, electrically connected to said control module, and configured to provide the electrical energy.

2. The electric ratchet wrench as claimed in claim 1, wherein
said rear ring section has a plurality of slots formed through an outer surface and an inner surface of said rear ring section, and
said sleeve member includes a plurality of protrusions formed on an inner surface thereof and engaging respectively said slots.

3. The electric ratchet wrench as claimed in claim 1, wherein:
said electric motor includes a spindle extending into said front space and rotatable about the first axis; and
said transmission subunit includes
an internal gear ring engaging said front ring section,
a plurality of planetary gears connected co-rotatably to said spindle and meshing with said internal gear ring, and
a gear plate meshing with and driven by said planetary gears to rotate and transmit the kinetic energy to said head driver.

4. The electric ratchet wrench as claimed in claim 3, wherein
said front ring section of said support ring has a plurality of grooves formed in an inner surface thereof and extending from a rim thereof toward said rear ring section, and
said internal gear ring includes a plurality of ribs formed on an outer surface thereof and engaging respectively said grooves.

5. The electric ratchet wrench as claimed in claim 3, wherein:
said sleeve member has
two receiving portion defining walls extending from an outer surface thereof in directions substantially parallel to the second axis and toward said support ring to define a receiving portion, and
two guiding grooves formed respectively in said receiving portion defining walls; and
said control unit further includes a trigger connected to said sleeve member, disposed in said receiving portion, operable to turn on said electric motor, and including two flange portions that are formed at two opposite sides thereof, that are received respectively in said guiding grooves, and that are movable relative to said guiding grooves in directions parallel to the second axis.

6. The electric ratchet wrench as claimed in claim 5, wherein
said control unit further includes a sensor electrically connected to said control module,
said trigger further includes a triggering portion extending toward and movable relative to said sensor in a direction substantially parallel to the second axis, and
said control module is configured to turn on said electric motor upon receipt of a sensing signal from said sensor when said sensor is pressed by said triggering portion.

7. The electric ratchet wrench as claimed in claim 6, wherein said trigger is connected pivotably to said sleeve member, and is pivotable relative to said sleeve member between a pressing position, where said triggering portion of said trigger presses against said sensor, and a normal position, where said triggering portion is spaced apart from said sensor and said trigger cooperates with the first axis to define an included angle ranging from 2 degrees to 5 degrees therebetween.

8. The electric ratchet wrench as claimed in claim 6, wherein said control unit further includes a light emitting element mounted to said sleeve member, electrically connected to said control module, disposed between said tool head unit and said trigger, and configured to emit a light beam substantially toward said second axis.

9. The electric ratchet wrench as claimed in claim 8, wherein an included angle is defined between the light beam emitted by said light emitting member and the first axis, and ranges from 40 degrees to 50 degrees.

10. The electric ratchet wrench as claimed in claim 8, wherein said control module is further configured to
turn on said light emitting element upon the receipt of the sensing signal,
turn off said electric motor when not receiving the sensing signal while said sensor is not pressed by said triggering portion, and
turn off said light emitting element after a predetermined period has elapsed since said electric motor is turned off.

11. The electric ratchet wrench as claimed in claim 1, wherein said control unit further includes an indicating member mounted to said wrench body unit for indicating a residual power of said battery module.

12. The electric ratchet wrench as claimed in claim 11, wherein
said control unit further includes a plurality of light emitting elements electrically connected to said control module and arranged in a direction parallel to the first axis,
said indicating member includes
a plurality of windows that are arranged in a direction parallel to the first axis and that are light transmissive, and
a plurality of light guiding strips, each of which is disposed between a respective one of said light emitting elements and a respective one of said windows for guiding a light beam emitted from the respective one of said light emitting elements toward the respective one of said windows, and
said control unit is further configured to turn on said light emitting elements based on the residual power of said battery module, a number of said light emitting elements that are turned on being in positive correlation to the residual power of said battery module.
